(19) United States
(12) Patent Application Publication
(10) Pub. No.: US 2010/0320336 A1
(43) Pub. Date: Dec. 23, 2010

(54) PC LINK

(76) Inventor: Po-Cheng Yang, Taoyuan Hsien (TW)

Correspondence Address: Yen Jung Sung, 21-80 38 St, #C8, Astoria, NY, 11105, US

(21) Appl. No.: 12/485,911

(22) Filed: Jun. 17, 2009

(51) Int. Cl. F16L 3/22

(52) U.S. Cl. 248/68.1

(57) ABSTRACT

A PC link having base, a cable hole defined in the base for receiving the power cable of an electric apparatus, a retaining arm extended from one lateral side of the base and defining with the base a retaining hole and a gap, and an elastically deformable guide portion extended from the free end of the retaining arm at one side for enabling said second cable be forced through said gap into said retaining hole and then held down in said retaining hole by said elastically deformable guide portion.

### BACKGROUND OF THE INVENTION

1. Field of the Invention

The present invention relates to PC (personal computer) links for securing cables and more particularly, to such a PC link, which prohibits separation between an electric plug and an electric outlet.

2. Description of the Related Art

When using an electric apparatus at a location where the power cable of the electric apparatus cannot reach a nearby electric outlet, an extension cable may be used to connect the power cable of the electric apparatus to the nearby electric outlet. However, the power cable or extension cable may be stretched accidentally, causing separation of the electric plug of the power cable from the electric socket of the extension cable. If the electric apparatus is for industrial use, sudden interruption of power supply will be dangerous to the user of the electric apparatus and may cause damage to the material under processing. Further, sudden separation of the electric plug from the electric socket may produce sparks that may cause a fire accident in an environment where there are inflammable substances.

### SUMMARY OF THE INVENTION

The present invention has been accomplished under the circumstances in view. It is the main object of the present invention to provide a PC link, which effectively prohibits separation between the electric plug of an electric apparatus and the electric socket of an extension cable, assuring a high level of safety of the use of the electric apparatus.

To achieve this and other objects of the present invention, a PC link comprises a base defining therein a cable hole for receiving a first cable, a retaining arm extended from one lateral side of the base and defining with the base a retaining hole and a gap, and a guide portion extended from the free end of the retaining arm at one side relative to the gap opposite to the base. The guide portion is elastically deformable so that a second cable can be forced through the gap into the retaining hole and then held down in the retaining hole by the guide portion.

### BRIEF DESCRIPTION OF THE DRAWINGS

FIG. 1 is an elevational view of a PC link in accordance with a first embodiment of the present invention.

FIG. 2 is a schematic elevational view showing a status of use of the PC link in accordance with the first embodiment of the present invention.

FIG. 3 is an elevational view of a PC link in accordance with a second embodiment of the present invention.

FIG. 4 is a schematic elevational view showing a status of use of the PC link in accordance with the second embodiment of the present invention.

FIG. 5 is an elevational view of a PC link in accordance with a third embodiment of the present invention.

FIG. 6 is a schematic elevational view showing a status of use of the PC link in accordance with the third embodiment of the present invention.

FIG. 7 is an elevational view of a PC link in accordance with a fourth embodiment of the present invention.

FIG. 8 is a schematic elevational view showing a status of use of the PC link in accordance with the fourth embodiment of the present invention.

### DETAILED DESCRIPTION OF THE PREFERRED EMBODIMENT

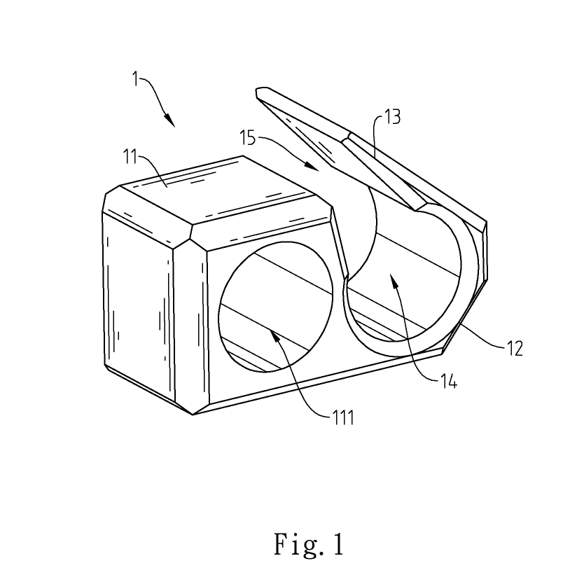

Referring to FIG. 1, a PC link 1 in accordance with a first embodiment of the present invention is shown having a base 11, a cable hole 111 cut through front and rear sides of the base 11, a retaining arm 12 extended from one lateral side of the base 11 and defining with the base 11 a retaining hole 14 and a gap 15, and a guide portion 13 formed integral with the free end of the retaining arm 12 at one side of the gap 15 opposite to the base 11. The cable hole 111 and the retaining hole 14 are axially kept in a parallel manner. According to this embodiment, the guide portion 13 is a beveled face formed integral with the free end of the retaining arm 12.

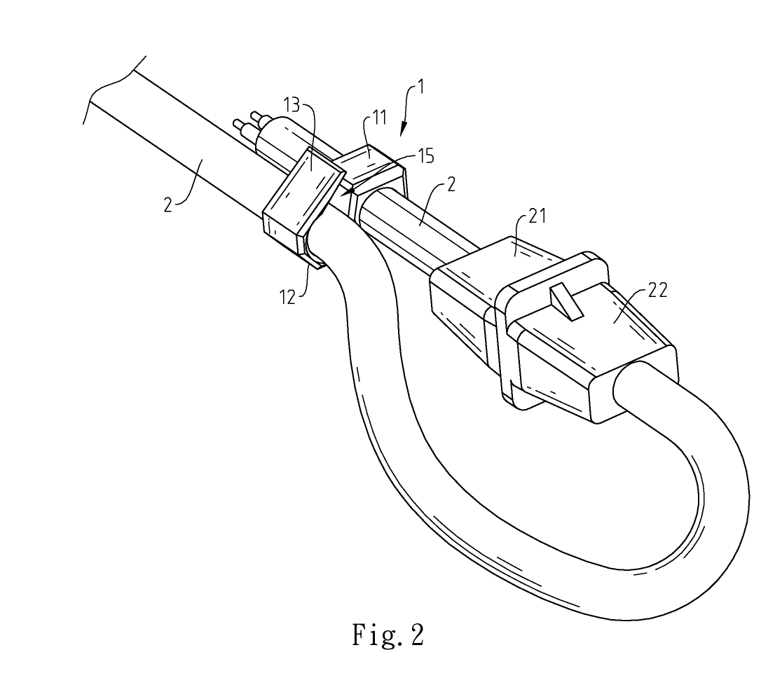

When using the PC link 1, as shown in FIG. 2, insert the cable 2 through the cable hole 111 on the base 11 to have the base 11 disposed adjacent to the electric plug 21 of the associating cable 2, and then insert the electric plug 21 into the electric socket 22 to electrically connect the electric plug 21 and the electric socket 22, and then force the cable 2 of the electric socket 22 through the gap 15 into the retaining hole 14. When forcing the cable 2 of the electric socket 22 through the gap 15 toward the retaining hole 14, the guide face 13 is temporarily deformed for allowing the cable 2 of the electric socket 22 to pass through the gap 15 into the retaining hole 14. After the cable 2 of the electric socket 22 reached the retaining hole 14, the guide face 13 immediately returns to its former shape subject to its elastic material property, holding down the cable 2 of the electric socket 22 reached the retaining hole 14. Because the cables 2 are kept in friction engagement with the PC link 1, the cables 2 do not displace relative to the PC link 1, and the electric plug 21 and the electric socket 22 are maintained connected positively.

Further, the PC link 1 can be made by means of an insert molding technique to have the base 11 be formed around the cable 2 so that the user can move the PC link 1 along the cable 2 to a suitable position.

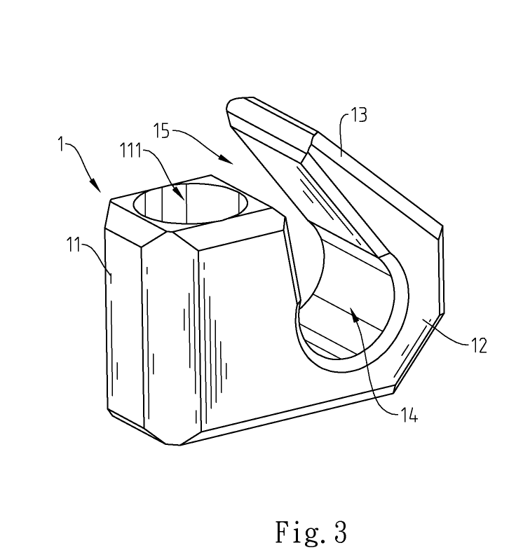

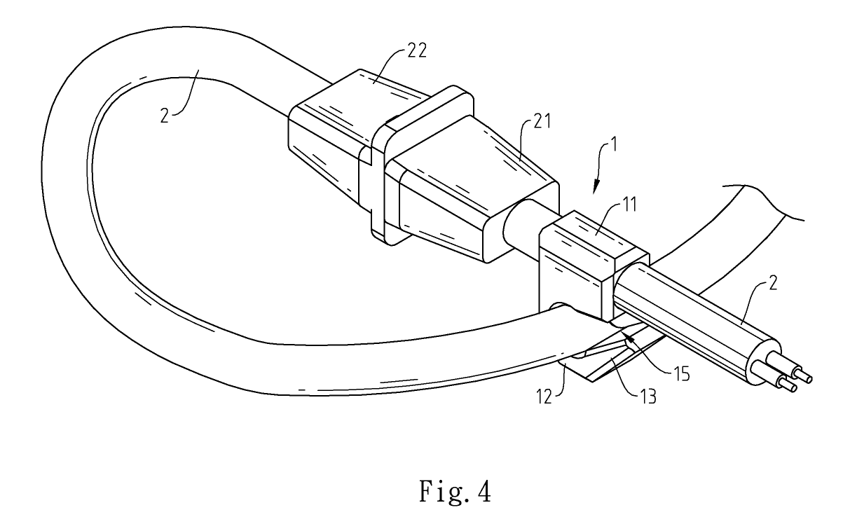

FIGS. 3 and 4 show a PC link 1 in accordance with a second embodiment of the present invention. According to this second embodiment, the PC link 1 is substantially similar to the aforesaid first embodiment with the exception that the cable hole 111 vertically extends the top and bottom sides of the base 11 so that the cable hole 111 and the retaining hole 14 extend perpendicular to each other. This second embodiment achieves the same effects as the aforesaid first embodiment.

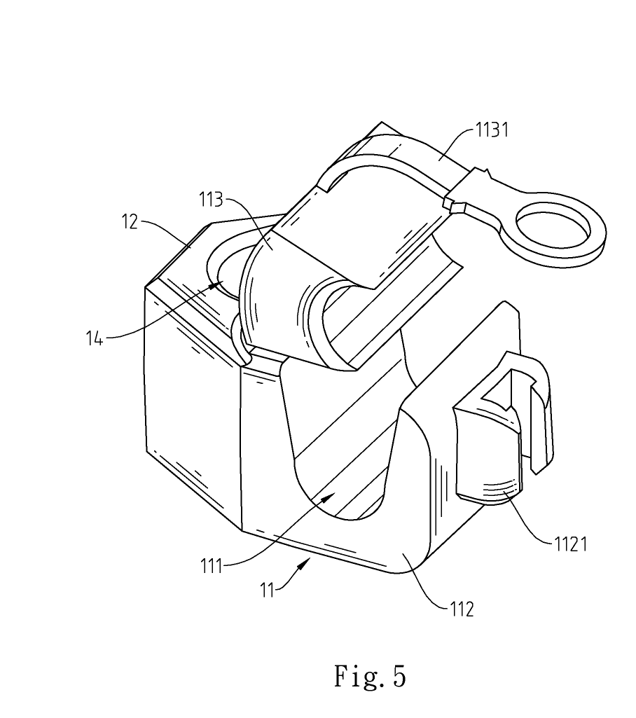

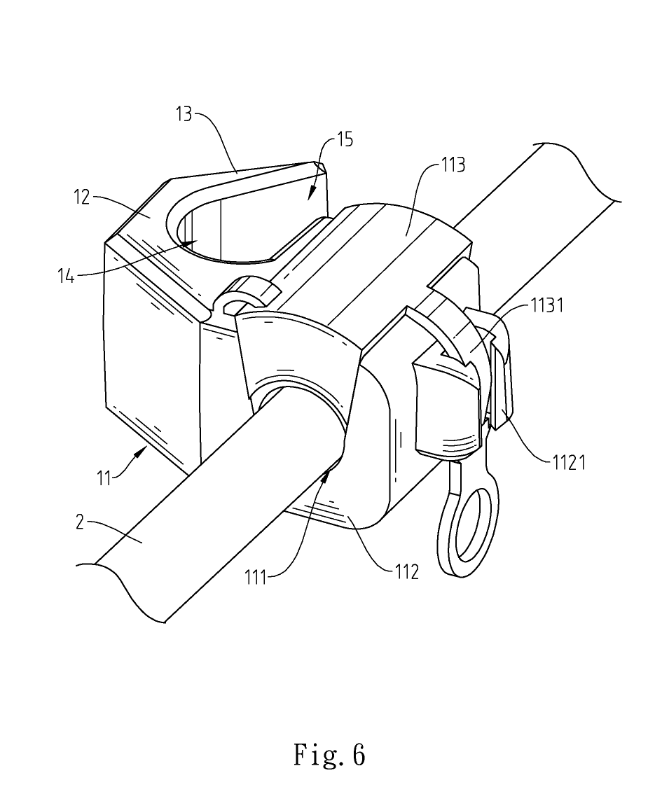

FIGS. 5 and 6 show a PC link 1 in accordance with a third embodiment of the present invention. According to this second embodiment, the base 11 of the PC link 1 comprises a substantially U-shaped holder portion 112 and a cover portion 113 hinged to one side of the U-shaped holder portion 112 relative to the retaining hole 111 defined in the base 11. The U-shaped holder portion 112 is provided with a female connection member 1121. The cover portion 113 is provided with a male connection member 1131 for fastening to the female connection member 1121 to secure the cover portion 113 to the U-shaped holder portion 112 in the close position.

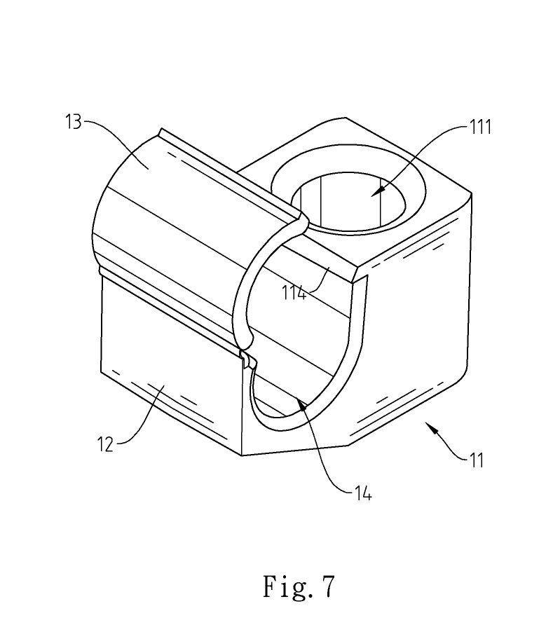

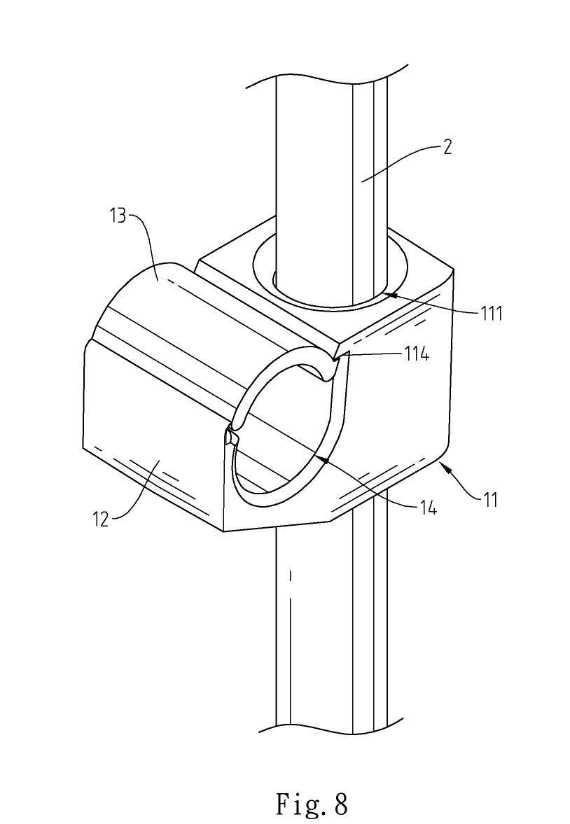

FIGS. 7 and 8 show a PC link 1 in accordance with a fourth embodiment of the present invention. According to this fourth embodiment, the base 11 has a stop flange 114 protruded from the top wall and suspending above the retaining hole 14. Further, the guide portion 13 is a smoothly arched plate member hinged to the free end of the retaining arm 12. After setting of the cable 2 in the retaining hole 14, the guide portion 13 is turned inwards toward the inside of the retaining hole 14 and forced into engagement with the stop flange 114 to hold down the cable 2 in the retaining hole 14.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A PC link for securing a first cable and a second cable, comprising:
a base defining therein a cable hole for receiving the first cable; and
a retaining arm extended from one lateral side of said base and defining with said base a retaining hole and a gap, and a guide portion extended from the free end of said retaining arm at one side relative to said gap opposite to said base, said guide portion being elastically deformable for enabling said second cable be forced through said gap into said retaining hole and then held down in said retaining hole by said guide portion.

2. The PC link as claimed in claim 1, wherein said cable hole and said retaining hole extend axially in a parallel manner.

3. The PC link as claimed in claim 1, wherein said cable hole and said retaining hole extend perpendicular to each other.

4. The PC link as claimed in claim 1, wherein said base comprises a substantially U-shaped holder portion, a cover portion hinged to one side of said U-shaped holder portion and movable relative to said U-shaped holder portion between an open position to let said first cable be set into said cable hole and a close position to hold down said first cable in said cable hole, a female connection member provided at said U-shaped holder portion, and a male connection member provided at said cover portion for fastening to said female connection member to secure said cover portion in said close position.

5. The PC link as claimed in claim 1, wherein said base has a stop flange protruded from a top wall thereof and suspending above said retaining hole; said guide portion is a smoothly arched plate member hinged to the free end of said retaining arm and turnable relative to said retaining arm between an open position for letting said second cable be set in said retaining hole and a close portion where said guide portion is forced into engagement with said stop flange to hold down said second cable in said retaining hole.
